(19) United States
(12) Patent Application Publication
(10) Pub. No.: US 2021/0222018 A1
(43) Pub. Date: Jul. 22, 2021

(54) INK AND PRINTED MATTER

(71) Applicant: DIC Corporation, Tokyo (JP)

(72) Inventors: Sumitra Cheawchan, Kitaadachi-gun (JP); Kouhei Hayakawa, Kitaadachi-gun (JP); Masashi Yamaguchi, Kitaadachi-gun (JP)

(73) Assignee: DIC Corporation, Tokyo (JP)

(21) Appl. No.: 15/734,702

(22) PCT Filed: Jun. 4, 2019
(86) PCT No.: PCT/JP2019/022111

§ 371 Date: Dec. 3, 2020

(30) Foreign Application Priority Data
Jun. 11, 2018 (JP) 2018-111128

(51) Int. Cl. C09D 11/322; C09D 11/107; B41M 5/00; B41M 5/50

(52) U.S. Cl. CPC C09D 11/322; B41M 5/50; B41M 5/0023; C09D 11/107

(57) ABSTRACT

A problem to be solved by the present invention is to provide an ink capable of producing a printed matter having excellent abrasion resistance even in the case of a very short drying time after printing and having high color development in the case of printing on plain paper. The inventors solved the problem by an ink containing a wax, a pigment, a pigment dispersing resin, an aqueous medium, and if required, a binder resin, wherein the content of the wax is within a range of 0.5% by mass to 2% by mass relative to the total amount of the ink and the content of the binder resin is 0% by mass to 2% by mass relative to the total amount of the ink.

### TECHNICAL FIELD

The present invention relates to an ink which can be used in various printing systems including, for example, an ink jet printing system.

### BACKGROUND ART

An ink jet printer is used for printing on various recording media including, for example, plain paper. An example of an ink known as an ink, which can be used for printing using the ink jet printer, is an ink containing a pigment, a binder resin, particulate wax, a moisturizer, and water, wherein the particle diameter of the wax is a small particle diameter of less than the thickness of a dry ink layer formed on an ink recorded surface and the particle diameter is 0.58 μm to 3 μm (refer to, for example, Patent Literature 1).

However, the ink contains the binder resin for the purpose of improving the abrasion resistance of printed matters obtained by printing on a corrugated board and paperboard and drying in a constant-temperature chamber (25° C., 50% RH) for 5 days, and thus color development may be decreased, for example, when used for printing on plain paper.

In addition, a printer capable of double-sided printing on a recording medium such as paper or the like is widely known as the ink jet printer.

The double-sided printing can be often performed by, for example, drying a single-sided printed matter, which is obtained by printing on one (front surface) of the sides of a recording medium, for about 15 seconds, then inverting the printed matter by a conveyance roller and an inversion mechanism in the printer, and printing on the other side (back surface) of the single-sided printed matter.

However, when the single-sided printed matter is inverted, the printed surface of the one-side printing matter may be damaged by contact of the printed surface with the conveyance roller, thereby decreasing print quality. In particular, when the drying time after the printing is as very short as about 15 seconds, the printed surface may be easily damaged during the inversion because it is relatively soft.

### CITATION LIST

### Patent Literature

PTL 1: Japanese Unexamined Patent Application Publication No. 2007-161823

### SUMMARY OF INVENTION

### Technical Problem

A problem to be solved by the present invention is to provide an ink capable of producing a printed matter having excellent abrasion resistance even in the case of a very short drying time after printing and having high color development in the case of printing on plain paper.

### Solution to Problem

The inventors of the present invention solved the problem by an ink containing a wax, a pigment, a pigment dispersing resin, an aqueous medium, and if required, a binder resin, wherein the content of the wax is within a range of 0.5% by mass to 2% by mass relative to the total amount of the ink and the content of the binder resin is 0% by mass to 2% by mass relative to the total amount of the ink.

### Advantageous Effects of Invention

An ink of the present invention can produce a printed matter having excellent abrasion resistance even in the case of a very short drying time after printing and having high color development in the case of printing on plain paper.

### DESCRIPTION OF EMBODIMENTS

An ink of the present invention contains a wax, a pigment, a pigment dispersing resin, an aqueous medium, and if required, a binder resin, wherein the content of the wax is within a range of 0.5% by mass to 2% by mass relative to the total amount of the ink and the content of the binder resin is 0% by mass to 2% by mass relative to the total amount of the ink.

Using the ink of the present invention can produce a printed matter having excellent abrasion resistance even in the case of a very short drying time after printing and having high color development in the case of printing on plain paper. The printed matter produced by using the ink of the present invention not only has, as described above, excellent abrasion resistance even in the case of a very short drying time after printing, but also has more excellent abrasion resistance by drying for about 24 hours.

An ink which can be used as the ink of the present invention is produced by dissolving or dispersing a wax, a pigment, a pigment dispersing resin, etc. in a solvent such as an aqueous medium, an organic solvent, or the like, and an aqueous ink produced by dissolving or dispersing the wax, etc. in an aqueous medium is preferably used.

First, the wax constituting the ink of the present invention is described.

The wax used in the present invention is used in order to impart excellent abrasion resistance and high color development to the printed matter.

For example, a polyolefin wax can be used as the wax.

A usable example of the polyolefin wax is a polymer of one or two or more olefinic hydrocarbons such as ethylene, propylene, butylene, and the like.

Specific examples which are preferably used as the polyolefin wax include polyethylene, polypropylene, polybutylene, polytetrafluoroethylene, and a polymer of ethylene and propylene or butylene; more preferably used are polyethylene, polytetrafluoroethylene, polypropylene, and polybutylene; still more preferably used are polyethylene and polytetrafluoroethylene; and particularly preferably used is polytetrafluoroethylene for producing an ink which can be printed in an ink jet printing system and which can produce a printed matter having excellent color development and abrasion resistance.

The wax which can maintain a particle shape on the surface of a recording medium is preferably used for producing a printed matter having more excellent abrasion resistance. In producing the ink containing the wax which can maintain a particle shape, a suspension or emulsion prepared by dispersing the wax in water in advance is preferably used.

In order to produce the ink which can maintain high color development, for example, even when printed on plain paper and which can produce a printed matter having more excellent abrasion resistance, the wax having a volume-average particle diameter of 0.04 μm to 2.0 μm is preferably used, the wax having a volume-average particle diameter of 0.5 μm to 1.5 μm is more preferably used, and the wax having a volume-average particle diameter within a range of 0.6 μm to 0.9 μm is particularly preferably used for satisfying both abrasion resistance and color development. Also, when polyethylene is used as the wax, the polyethylene having a volume-average particle diameter of 0.81 m to 1.1 μm is preferably used for producing a printed matter having excellent abrasion resistance. The volume-average particle diameter is a value measured at a cell temperature of 25° C. by using Microtrac UPA150EX (manufactured by Nikkiso Co., Ltd.).

The wax within a pH range of 7 to 14 is preferably used, and the wax within a pH range of 7 to 11 is preferably used in order to enable its use for production of a printed matter having excellent abrasion resistance even in the case of a very short drying time after printing and having high color development in the case of printing on plain paper and to maintain good storage stability of the ink.

The wax is used within a range of 0.5% by mass to 2% by mass relative to the total amount of the ink of the present invention. This makes it possible to produce an ink which can produce a printed matter having excellent abrasion resistance even in the case of a very short drying time after printing and having high color development in the case of printing on plain paper.

The wax is more preferably used within a range of 0.7% by mass to 1.5% by mass relative to the total amount of the ink of the present invention in order to produce a printed matter having more excellent abrasion resistance even in the case of a very short drying time after printing and having higher color development in the case of printing on plain paper.

Next, the pigment used in the present invention is described.

For example, organic pigments or inorganic pigments can be used alone or in combination of two or more as the pigment.

Usable examples of the organic pigments include a quinacridone-based pigment, a quinacridone quinone-based pigment, a dioxazine-based pigment, a phthalocyanine-based pigment, a phthalone-based pigment, an isoindolinone-based pigment, a methine/azomethine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an azolake-based pigment, an insoluble azo-based pigment, a condensed azo-based pigment, and the like.

Usable examples of the inorganic pigments include titanium dioxide, zinc oxide, iron oxide, chromium oxide, iron black, cobalt blue, alumina white, iron oxide yellow, viridian, zinc sulfide, lithopone, cadmium yellow, vermilion, cadmium red, chrome yellow, molybdate orange, zinc chromate, strontium chromate, white carbon, clay, talc, ultramarine blue, precipitated barium sulfate, barite powder, calcium carbonate, white lead, Plussian blue, manganese violet, carbon black, aluminum powder, pearl-based pigments, and the like.

A pigment self-dispersible in an aqueous medium can also be used as the pigment.

The pigment is preferably used within a range of 0.1% by mass to 20% by mass relative to the total amount of the ink, and is preferably used within a range of 5% by mass to 10% by mass in order to produce an ink having good storage stability and having excellent ejection stability when applied to an ink jet printing method.

Next, the pigment dispersing resin used in the present invention is described.

The pigment dispersing resin is used for imparting water dispersibility to the pigment.

For example, a pigment dispersing resin having an anionic group can be used as the pigment dispersing resin. Examples of the anionic group include a carboxyl group, a sulfonate group, a phosphate group, and the like.

A resin having a hydrophobic structural unit and a structural unit derived from a hydrophilic anionic unit is particularly preferably used as the pigment dispersing resin having an anionic group in order to produce an ink which can form a printed matter having a high degree of design freedom for a structure, which maintains stability of the ink of the invention, and also having excellent color development on plain paper.

For example, the pigment dispersing resin having a structural unit derived from styrene and a structural unit derived from acrylic acid can be used as the resin having a hydrophobic structural unit and a structural unit derived from a hydrophilic anionic unit.

A resin having an acid value within a range of 60 to 300 mgKOH/g is preferably used as the resin having a hydrophobic structural unit and a structural unit derived from a hydrophilic anionic unit, and a resin having an acid value within a range of 100 to 180 mgKOH/g is suitably used from the viewpoint of balancing pigment dispersibility, ink stability, and high print density.

From the viewpoint of balancing pigment dispersibility in an aqueous medium, ink stability, abrasion resistance, high print density, and further ejection properties, the resin used as the resin having a hydrophobic structural unit and a structural unit derived from a hydrophilic anionic unit preferably has a weight-average molecular weight within a range of 3,000 to 50,000, more preferably within a range of 4,000 to 40,000, still more preferably within a range of 5,000 to 30,000, and particularly preferably within a range of 5,000 to 20,000.

In order to maintain excellent ejection stability without the resin being deteriorated by the influence of heat derived from a thermal jet system even when the ink of the present invention is applied to a thermal jet-system ink jet printing method, the one used as the resin having a hydrophobic structural unit and a structural unit derived from a hydrophilic anionic unit preferably has a glass transition temperature within a range of 60° C. to 150° C. and more preferably within a range of 70° C. to 150° C.

As the resin having a hydrophobic structural unit and a structural unit derived from a hydrophilic anionic unit, preferred is a resin which can be made water dispersible by neutralization of the anionic group, and preferred is a resin having the ability of being capable of forming stable water-dispersed particles without using a dispersion stabilizer such as an emulsifier or the like under the function of a basic compound serving as a neutralizer.

When a resin having an anionic group is used as the pigment dispersing resin, an inorganic basic compound and an organic basic compound can be used as a basic compound which can be used for neutralizing an anionic group. In order to obtain an ink having more excellent storage stability, the inorganic basic compound is preferably used as the basic compound.

Usable examples of the inorganic basic compound include an alkali metal hydroxide, ammonium hydroxide, and the like, and an alkali metal hydroxide such as potassium hydroxide, sodium hydroxide, or the like is preferably used for imparting more excellent dispersion stability to the pigment. From the viewpoint of improving mixability, an aqueous solution of a concentration of 20% by mass to 50% by mass prepared by dissolving or dispersing in water in advance can be used as the inorganic basic compound.

Usable examples of the organic basic compound include amines such as methylamine, dimethylamine, trimethylamine, ethylamine, diethylamine, triethylamine, diethanolamine, triethanolamine, and the like. The amine is generally liquid and thus can be used as it is.

The content of the basic compound is preferably adjusted so that the neutralization rate of the resin having an anionic group is preferably 50% or more and more preferably 80% or more in order to improve the dispersion rate in the aqueous medium and secure good dispersion stability and long-term storage stability. The upper limit value of the neutralization rate is not particularly limited, but is preferably 200% or less and more preferably 120% or less in order to substantially achieve stability of the ink and prevent gelation even in long-term storage. The neutralization rate is a value calculated by the following formula.

Neutralization rate (%)=[{mass of basic compound (g)×56.11×1000}/{acid value of pigment dispersing resin (mgKOH/g)×equivalent of basic compound×mass of pigment dispersing resin (g)}]×100

More specifically, usable examples of the pigment dispersing resin include a polyester resin having the anionic group, an epoxy resin having the anionic group, a urethane resin having the anionic group, an acrylic acid resin having the anionic group, a maleic acid resin having the anionic group, a styrene resin having the anionic group, a vinyl copolymer having the anionic group, such as a polyvinyl acetate resin having the anionic group, and the like.

Usable examples of the pigment dispersing resin include poly(meth)acrylic acid, vinyl acetate-acrylic acid ester copolymers, acrylic acid-acrylic acid alkyl ester copolymers, styrene-(meth)acrylic acid copolymers, styrene-(meth)acrylic acid-acrylic acid alkyl ester copolymers, styrene-maleic acid copolymers, vinyl acetate-maleic acid ester copolymers, vinyl acetate-crotonic acid copolymers, vinyl acetate-acrylic acid copolymers, and the like.

Next, the aqueous medium used in the present invention is described.

For example, water, a water-soluble organic solvent, and the like can also be used as the aqueous medium. Pure water such as ion exchange water, ultrafiltered water, reverse osmosis membrane-treated water, distilled water, or the like, or ultrapure water can be used as the water. Also, water sterilized by ultraviolet irradiation, hydrogen peroxide addition, or the like is preferably used as the water because the occurrence of mildew or bacteria can be prevented when an aqueous pigment dispersion, an ink using it, or the like is stored for a long period.

If required, an ink containing a binder resin can be used as the ink of the present invention. However, when printed on plain paper, the ink containing the binder resin easily suppresses the aggregation of the pigment and thus the ink may cause a decrease in color development of a printed matter. Therefore, the binder resin is used within a range of 0% by mass to 2% by mass relative to the total amount of the ink. The ink having a binder resin content exceeding 2% by mass may cause a decrease in the color development.

On the other hand, in the present invention, simply when the content of the binder resin is adjusted within a range of 0% by mass to 2% by mass, it may be impossible to produce a printed matter having excellent abrasion resistance even in the case of a short drying time after printing and having high color development in the case of printing on plain paper. Only when the content of the binder resin is adjusted within a range of 0% by mass to 2% by mass and the content of the wax is adjusted within a range of 0.5% by mass to 2% by mass, the problem of the present invention can be solved.

The content of the binder resin relative to the total amount of the ink is preferably within a range of 0% by mass to 1.5% by mass, more preferably 0% by mass to 0.5% by mass, and particularly preferably 0% by mass for producing an ink which can produce a printed matter having excellent abrasion resistance even in the case of a short drying time after printing and having high color development in the case of printing on plain paper.

Examples of the binder resin include a polyurethane resin, an acrylic resin, an epoxy resin, a polyester resin, shellac, and the like.

The amount of use of the binder resin having a weight-average molecular weight of 10,000 or more is preferably decreased.

The ink of the present invention may be mixed with, for example, an alkali agent, a pH adjuster, a surfactant, an antiseptic agent, a chelating agent, a plasticizer, an antioxidant, an ultraviolet absorber, etc. according to necessary characteristics.

As the ink of the present invention, also can be used an ink, if required, containing additives such as a wetting agent and the like in addition to the components described above.

Examples of the wetting agent include polyhydric alcohols such as ethylene glycol, glycerol, and the like; polyhydric alcohol ethers such as ethylene glycol monoethyl ether, ethylene glycol monobutyl ether, and the like; glycerin polyoxyalkylene adducts; nitrogen-containing heterocyclic compounds such as N-methyl-2-pyrrolidone, γ-butyrolactone, and the like; amides such as N,N-dimethylformamide and the like; organic amines such as triethylamine and the like; sulfur-containing compounds such as dimethylsulfoxide and the like; propylene carbonate; ethylene carbonate; and the like. These can be used alone or in combination of two or more.

The wetting agent having a high boiling point is preferably used for uniformly dispersing the pigment and the pigment dispersing resin. More preferred examples thereof include polyhydric alcohols such as ethylene glycol, propylene glycol, diethylene glycol, dipropylene glycol, triethylene glycol, polyethylene glycol, polypropylene glycol, glycerin, glycerin polyethylene oxide adduct, and the like.

The wetting agent is preferably used within a range of 10% by mass to 300% by mass and more preferably within a range of 30 by mass to 200% by mass relative to the total amount of the pigment.

The ink of the present invention can be produced by, for example, mixing a pigment dispersion, which is prepared by mixing the pigment, the pigment dispersing resin, the aqueous medium, and if required, the basic compound and the wetting agent, with the wax and, if required, the aqueous medium, the wetting agent, and the binder resin.

The pigment dispersion can be produced through, for example, a step [1] of kneading a composition containing the pigment and the pigment dispersing resin and, if required, the basic compound and the wetting agent, a step [2] of diluting and dispersing the kneaded product produced in the step [1] in the aqueous medium, etc.

In the steps [1] and [2], proper selection of the pigment dispersing resin can significantly improve the affinity of the pigment dispersing resin for the pigment, can improve dispersion stability of the aqueous pigment dispersion, and can improve gloss, durability, water resistance, etc. of the printed matter formed by printing on plain paper with the ink produced using the pigment dispersion.

The step [1] can use an apparatus, for example, such as a roll mill, a Henschel mixer, a pressure kneader, a planetary mixer, or the like. An apparatus such as a Henschel mixer having a stirring tank and a stirring blade, in which the stirring tank can be sealed, a pressure kneader, a planetary mixer, or the like is preferably used because the solid content ratio of the composition can be maintained constant in the step [1] and the kneaded product with a good dispersion state can be produced. Also, a planetary mixer is preferably used because kneading can be performed within a wide viscosity range.

In addition, the step [2] is a step of diluting and dispersing the kneaded product produced in the step [1] in the aqueous medium.

The aqueous pigment dispersion prepared by the method described above is preferably treated by centrifugal separation or filtration for removing coarse particles and aggregated particles derived from the raw materials such as the pigment and for preventing the occurrence of clogging or the like of ink ejection nozzles when the ink of the present invention is applied to an ink jet printing method.

The ink of the present invention can be produced by mixing the pigment dispersion prepared by the method described above, the wax, and if required, the aqueous medium, the wetting agent, and the binder resin.

Specifically, the ink of the present invention can be produced by supplying the aqueous medium such as pure water or the like to the pigment dispersion, next supplying the wetting agent if required, stirring the resultant mixture at room temperature for 30 to 90 minutes, then supplying an emulsion prepared in advance by dispersing the wax in the aqueous medium, further stirring the mixture at room temperature for 30 to 90 minutes, next supplying an aqueous potassium hydroxide solution with a potassium hydroxide concentration of 5% by mass to adjust the ink to pH 8.5 to 9.8, and then stirring the ink at room temperature for 30 to 90 minutes.

When the aqueous pigment dispersion is required to be diluted, the same material as the wetting agent used for dispersing the pigment is preferably used for dilution because the ink viscosity and the pigment concentration can be easily adjusted and the permeability of the ink into plain paper can be easily adjusted.

As the ink of the present invention produced by the method described above, for example, an ink having a viscosity within a range of 1 to 10 mPa-sec is preferably used. In particular, when the ink of the present invention is ejected in an ink jet printing system described later, an ink having a viscosity within a range of 1 to 6 mPa-sec is more preferably used.

The ink of the present invention produced by the method described above is preferably used with a mass ratio of the pigment of 1% by mass to 10% by mass and, in order to obtain the ink having more excellent storage stability, the ink is particularly preferably used with a mass ratio of the pigment of 3% by mass to 8% by mass relative to the total amount of the ink.

The ink of the present invention can be used for printing on a recording medium.

For example, finely coated paper with a surface thinly coated with a chemical for accelerating drying of the ink can be used as the recording medium. The ink of the present invention can produce a printed matter having high glass even when plain paper is selected as the recording medium.

Typical examples of the plain paper include PPC paper used for an electrophotographic copying machine and the like. Every sheet of plain paper is different in the amount of waste-paper pulp used, bleach degree, and the like and in thickness according to brands. However, an ink-receiving layer or the like is not coated in exchange for low cost. Therefore, in particular, in the case of double-sided printing with an ink jet printing system, when a single-sided printed matter produced by printing on one (front surface) of the sides of plain paper is inverted, the print surface of the single-sided printed matter is damaged by contact of the print surface with a conveyance roller, thereby easily decreasing print quality.

The ink of the present invention can produce printed matter with little damage and high color development even in the case of double-sided printing on the plain paper.

The ink of the present invention can be applied to various printing systems but can be preferably used exclusively in a printing scene by an ink jet printing system.

Examples of the ink jet printing system include a continuous injection type (a charge control type, a spray type, and the like), an on-demand type (a piezo system, a thermal system, an electrostatic attraction system, and the like), and the like. The ink of the present invention is preferred for printing in a thermal-type ink jet printing system. When the aqueous ink for ink jet recording is basically applied to various ink jet systems, the ink can be very stably ejected and, in addition, good scratch resistance and abrasion resistance of the formed image can be realized.

As described above, the printed matter produced by printing with the ink of the present invention can satisfy both excellent abrasion resistance and high color development and thus can be used for, for example, a document obtained by printing by using a printer capable of double-sided printing on plain paper, and the like.

### EXAMPLES

### Example 1

In a planetary mixer with a volume of 50 L (manufactured by Inoue Mfg., Inc.), 500 parts by mass of Joncryl JDX-6639 (manufactured by BASF Corporation, an aqueous solution of styrene acrylic resin, weight-average molecular weight: 8000, acid value: 120 to 130, glass transition point: 70° C., viscosity: 1500 mPa-s, pH 8, nonvolatile content: about 29% by mass) and 5000 parts by mass of a magenta pigment (FASTOGEN Super Magenta RY, manufactured by DIC Corporation) were charged, and a jacket was heated.

After the temperature of the contents in the planetary mixer reached 60° C., the contents were mixed by stirring under the conditions including a number of rotations of 80 rotations/min and a number of revolutions of 25 revolutions/min.

Five minutes after the start of stirring, 3700 parts by mass of triethylene glycol and 172 parts by mass of an aqueous potassium hydroxide solution of 34% by mass were added.

Then, mixing was continued until 120 minutes had passed from the point when the current value of the planetary mixer showed the maximum current value, thereby producing a kneaded product.

Next, 10000 parts by mass of ion exchange water of 60° C. was added to the kneaded product over 2 hours, preparing a liquid mixture. The ratio by mass of the styrene acrylic resin contained in the liquid mixture to the magenta pigment was 0.029.

Next, ion exchange water and triethylene glycol were added to the liquid mixture to produce a magenta aqueous pigment dispersion having a magenta pigment concentration of 14.3% by mass and a triethylene glycol concentration of 100% by mass relative to the magenta pigment.

In a 100-ml plastic container, 2.1 parts by mass of Nanoflon W50C (water-dispersible polytetrafluoroethylene wax (PTFE wax), manufactured by Shamrock Technologies, Inc.), 5.6 parts by mass of 2-pyrrolidinone (manufactured by BASF Corporation), 5.6 parts by mass of triethylene glycol monobutyl ether (manufactured by Tokyo Chemical Industry Co., Ltd.), 2.1 parts by mass of purified glycerin (manufactured by Kao Corporation), 0.3 parts by mass of Surfynol 440 (nonionic surfactant, 2,4,7,9-tetramethyl-5-decyne-4,7-diol, manufactured by Evonik Japan Co., Ltd.), and ion exchange water were placed and stirred for 1 hour, and then 24.5 parts by mass of the magenta aqueous pigment dispersion was further added and stirred for 1 hour.

Next, the resultant mixture was adjusted within a range of pH 9 to 9.8 by using a 5 mass % aqueous potassium hydroxide solution and then filtered with a filter having a pore diameter of 5 to 10 μm, producing a total of 70 parts by mass of an aqueous ink (magenta pigment concentration: 5% by mass).

### Example 2

An aqueous ink (magenta pigment concentration: 5% by mass) was produced by the same method as in Example 1 except that 2.6 parts by mass of Chemipearl W900 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Example 3

An aqueous ink (magenta pigment concentration: 5% by mass) was produced by the same method as in Example 1 except that 2.6 parts by mass of Chemipearl W4005 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Example 4

An aqueous ink (magenta pigment concentration: 5% by mass) was produced by the same method as in Example 1 except that 2.6 parts by mass of Chemipearl W950 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Example 5

An aqueous ink (magenta pigment concentration: 5% by mass) was produced by the same method as in Example 1 except that 2.6 parts by mass of Chemipearl W401 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Example 6

An aqueous ink (magenta pigment concentration: 5% by mass) was produced by the same method as in Example 1 except that 2.6 parts by mass of Chemipearl W700 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Example 7

An aqueous ink (magenta pigment concentration: 5% by mass) was produced by the same method as in Example 1 except that 2.6 parts by mass of Chemipearl WF640 (water-dispersible polyethylene wax manufactured by Mitsui Chemicals, Inc.) was used in place of 2.1 parts by mass of Nanoflon W50C (water-dispersible polytetrafluoroethylene wax (PTFE wax), manufactured by Shamrock Technologies, Inc.).

### Comparative Example 1

An aqueous ink (magenta pigment concentration: 5% by mass) was produced by the same method as in Example 1 except that the amount of Nanoflon W50C (water-dispersible polytetrafluoroethylene wax (PTFE wax), manufactured by Shamrock Technologies, Inc.) used was changed to 0 parts by mass from 2.1 parts by mass.

### Comparative Example 2

The carboxyl groups possessed by polyurethane (weight-average molecular weight: 42000, acid value: about 41 mgKOH/g), which was the reaction product of 30 parts by mass of isophorone diisocyanate, 10 parts by mass of 2,2-dimethylolpropinic acid, and 60 parts by mass of polyoxytetramethylene ether glycol (hydroxyl value: 110), were 100% neutralized with potassium hydroxide, preparing a polyurethane water dispersion B (solid content: 20% by mass).

Next, in a 100-ml plastic container, 5.6 parts by mass of 2-pyrrolidinone (manufactured by BASF Corporation), 5.6 parts by mass of triethylene glycol monobutyl ether (manufactured by Tokyo Chemical Industry Co., Ltd.), 2.1 parts by mass of purified glycerin (manufactured by Kao Corporation), 0.3 parts by mass of Surfynol 440 (nonionic surfactant, 2,4,7,9-tetramethyl-5-decyne-4,7-diol, manufactured by Evonik Japan Co., Ltd.), and ion exchange water were placed and stirred for 1 hour. Then, 24.5 parts by mass of the aqueous magenta pigment dispersion was further added and stirred for 1 hour.

After the stirring, 5.3 parts by mass of the polyurethane water dispersion B was supplied to the plastic container and mixed.

Then, the resultant mixture was adjusted within a range of pH 9 to 9.8 by using a 5 mass % aqueous potassium hydroxide solution, producing a total of 70 parts by mass of an aqueous ink (magenta pigment concentration: 5% by mass).

### Comparative Example 3

An aqueous ink (magenta pigment concentration: 5% by mass) was produced by the same method as in Comparative Example 2 except that the amount of the polyurethane water dispersion B used was changed to 14 parts by mass from 5.3 parts by mass, and 2.1 parts by mass of Nanoflon W50C was used.

Table 1 shows the characteristic values of the wax used in each of the examples and the comparative examples.

TABLE 1

| | Volume- | | | | |
|---|---|---|---|---|---|
| | average | Solid | | | |
| | particle | content | | | |
| | diameter | (% by | | Density | Viscosity |
| Wax name | (μm) | mass) | pH | (kg/m³) | (mPa · s) |
| NanoflonW50C | 0.89 | 50 | 7-9 | — | — |
| Chemipearl W900 | 0.56 | 40 | 11 | 970 | 300 |
| Chemipearl W4005 | 0.70 | 40 | 11 | 920 | 400 |
| Chemipearl W950 | 0.80 | 40 | 11 | 920 | 300 |
| Chemipearl W401 | 0.89 | 40 | 9 | 920 | 500 |
| Chemipearl W700 | 0.97 | 40 | 10 | 970 | 800 |
| Chemipearl WF640 | 1.09 | 40 | 11 | 920 | 400 |

TABLE 2

| | Example | Example | Example | Example | Example | Example | Example | Comparative | Comparative | Comparative |
|---|---|---|---|---|---|---|---|---|---|---|
| | 1 | 2 | 3 | 4 | 5 | 6 | 7 | Example 1 | Example 2 | Example 3 |
| Magenta | 24.5 | 24.5 | 24.5 | 24.5 | 24.5 | 24.5 | 24.5 | 24.5 | 24.5 | 24.5 |
| aqueous pigment | | | | | | | | | | |
| dispersion (parts | | | | | | | | | | |
| by mass) | | | | | | | | | | |
| Polyurethane | — | — | — | — | — | — | — | — | 5.3 | 14.0 |
| water dispersion | | | | | | | | | | |
| B (parts by mass) | | | | | | | | | | |
| Nanoflon W50C | 2.1 | — | — | — | — | — | — | — | — | 2.1 |
| (parts by mass) | | | | | | | | | | |
| Chemipearl W900 | — | 2.6 | — | — | — | — | — | — | — | — |
| (parts by mass) | | | | | | | | | | |
| Chemipearl W4005 | — | — | 2.6 | — | — | — | — | — | — | — |
| (parts by mass) | | | | | | | | | | |
| Chemipearl W950 | — | — | — | 2.6 | — | — | — | — | — | — |
| (parts by mass) | | | | | | | | | | |
| Chemipearl W401 | — | — | — | — | 2.6 | — | — | — | — | — |
| (parts by mass) | | | | | | | | | | |
| Chemipearl W700 | — | — | — | — | — | 2.6 | — | — | — | — |
| (parts by mass) | | | | | | | | | | |
| Chemipearl WF640 | — | — | — | — | — | — | 2.6 | — | — | — |
| (parts by mass) | | | | | | | | | | |
| 2-Pyrolidinone | 5.6 | 5.6 | 5.6 | 5.6 | 5.6 | 5.6 | 5.6 | 5.6 | 5.6 | 5.6 |
| (parts by mass) | | | | | | | | | | |
| Triethylene glycol | 5.6 | 5.6 | 5.6 | 5.6 | 5.6 | 5.6 | 5.6 | 5.6 | 5.6 | 5.6 |
| monobutyl ether | | | | | | | | | | |
| (parts by mass) | | | | | | | | | | |
| Purified glycerin | 2.1 | 2.1 | 2.1 | 2.1 | 2.1 | 2.1 | 2.1 | 2.1 | 2.1 | 2.1 |
| (parts by mass) | | | | | | | | | | |
| Surfynol 440 | 0.3 | 0.3 | 6.3 | 0.3 | 0.3 | 0.3 | 0.3 | 0.3 | 0.3 | 0.3 |
| (parts by mass) | | | | | | | | | | |
| 5 mass % aqueous | 4.4 | 4.4 | 4.4 | 4.4 | 4.4 | 4.4 | 4.4 | 4.4 | 4.4 | 4.4 |
| potassium | | | | | | | | | | |
| hydroxide solution | | | | | | | | | | |
| (parts by mass) | | | | | | | | | | |
| Ion exchange | Balance | Balance | Balance | Balance | Balance | Balance | Balance | Balance | Balance | Balance |
| water (parts by | | | | | | | | | | |
| mass) | | | | | | | | | | |
| Total (parts by | 70 | 70 | 70 | 70 | 70 | 70 | 70 | 70 | 70 | 70 |
| mass) | | | | | | | | | | |

### [Color Development 1 Evaluation Method (Bar Coater)]

The aqueous ink produced in each of the examples and the comparative examples was coated on PPC paper (waste paper mixing ratio: 30%, paper thickness: about 90 μm, basis weight: about 68 g/m²) by using a bar coater (wire No. 3, film thickness: 6.87 μm, manufactured by Daiichi Rika Co., Ltd.) and dried by being allowed to stand in a room-temperature atmosphere for 24 hours, forming a test piece A.

The optical density (OD value) of the coating surface of the test piece A was measured by using a densitometer (eXact series, X-Rite Inc.).

A: The OD value is 1% or more higher than the OD value of the test piece of Comparative Example 1.

B: The OD value is within ±1% from the OD value of the test piece of Comparative Example 1.

C: The OD value is 1% or more lower than the OD value of the test piece of Comparative Example 1.

### [Color Development 2 Evaluation Method (Jet Printing)]

The aqueous ink produced in each of the examples and the comparative examples was printed by 100% solid-printing in a draft mode (1 pass) on PPC paper (waste paper mixing ratio: 30%, paper thickness: about 90 μm, basis weight: about 68 g/m²) using a commercial thermal jet-system ink jet printer (Envy 4500, manufactured by Hewlett-Packard Company) and dried by being allowed to stand in a room-temperature atmosphere for 24 hours, forming a test piece B.

The optical density (OD value) of the printed surface of the test piece B was measured by using a densitometer (eXact series, X-Rite Inc.).

A: The OD value is over 1% higher than the OD value of the test piece of Comparative Example 1.

B: The OD value is within ±1% from the OD value of the test piece of Comparative Example 1.

C: The OD value is over 1% lower than the OD value of the test piece of Comparative Example 1.

[Abrasion Resistance 1 Evaluation Method (Immediately after Printing)]

First, a sheet of coated paper (gloss, HP Brochure paper manufactured by Hewlett-Packard Company) was attached as friction paper to a weight of 200 g provided on a Gakushin-type rubbing tester (RT-300, manufactured by Daiei Kagaku Seiki Mfg. Co., Ltd.).

Next, the aqueous ink produced in each of the examples and the comparative examples was coated on the coated paper (gloss, HP Brochure paper manufactured by Hewlett-Packard Company) using a bar coater (wire No. 3, film thickness: 6.87 μm, manufactured by Daiichi Rika Co., Ltd.).

After the coating, the coated paper was allowed to stand in a room-temperature atmosphere for 1 minutes to form a test piece C, and the coating surface of the test piece C was rubbed in one reciprocation by using the Gakushin-type rubbing tester.

The coated surface of the test piece C after the rubbing was visually observed to evaluate the presence of scratch (scratch exposing the surface of the coated paper) according to the following evaluation criteria:

A: The ratio of the scratch area to the area of the coated surface is less than 5%.

B: The ratio of the scratch area to the area of the coated surface is 5% or more and less than 30%.

C: The ratio of the scratch area to the area of the coated surface is 30% or more.

[Abrasion Resistance 2 Evaluation Method (after the Passage of 24 Hours from Printing)]

First, a sheet of coated paper (gloss, HP Brochure paper manufactured by Hewlett-Packard Company) was attached as friction paper to a weight of 200 g provided on a Gakushin-type rubbing tester (RT-300, manufactured by Daiei Kagaku Seiki Mfg. Co., Ltd.).

Next, the aqueous ink produced in each of the examples and the comparative examples was coated on the coated paper (gloss, HP Brochure paper manufactured by Hewlett-Packard Company) using a bar coater (wire No. 3, film thickness: 6.87 μm, manufactured by Daiichi Rika Co., Ltd.).

After the coating, the coated paper was allowed to stand in a room-temperature atmosphere for 24 hours to form a test piece D, and the coating surface of the test piece D was rubbed by 5 reciprocations of rubbing using the Gakushin-type rubbing tester.

The coated surface of the test piece D after the rubbing was visually observed to evaluate the presence of scratch (scratch exposing the surface of the coated paper) according to the following evaluation criteria:

A: The ratio of the scratch area to the area of the coated surface is less than 5%.

B: The ratio of the scratch area to the area of the coated surface is 5% or more and less than 30%.

C: The ratio of the scratch area to the area of the coated surface is 30% or more.

### [Abrasion Resistance 3 Evaluation Method (Double-Sided Printing by Jet Printing Method)]

The aqueous ink produced in each of the examples and the comparative examples was printed in a maximum (4 passes) mode to form a strip-like image with the print density changing from 60% to 80% on either surface of coated paper (gloss, HP Brochure paper manufactured by Hewlett-Packard Company) using a commercial thermal jet-system ink jet printer (Envy 4500, manufactured by Hewlett-Packard Company), thereby forming a test piece E.

The printed surfaces of the test piece E were evaluated by visual observation according to the following evaluation criteria:

A: Scratch was not at all confirmed on the printed surfaces.

B: Scratch was confirmed on the printed surfaces, but the coated paper was not exposed.

C: Scratch was confirmed on the printed surfaces, and the coated paper was exposed.

TABLE 3

| | Example | | | | | | | Comparative Example | | |
|---|---|---|---|---|---|---|---|---|---|---|
| | 1 | 2 | 3 | 4 | 5 | 6 | 7 | 1 | 2 | 3 |
| Polyurethane water dispersion B (parts by mass) | 0 | 0 | 0 | 0 | 0 | 0 | 0 | 0 | 5.3 | 14.0 |
| NanoflonW50C | 2.1 | | | | | | | | | 2.1 |
| (parts by mass) | | | | | | | | | | |
| Chemipearl W900 | | 2.6 | | | | | | | | |
| (parts by mass) | | | | | | | | | | |
| Chemipearl W4005 | | | 2.6 | | | | | | | |
| (parts by mass) | | | | | | | | | | |
| Chemipearl W950 | | | | 2.6 | | | | | | |
| (parts by mass) | | | | | | | | | | |
| Chemipearl W401 | | | | | 2.6 | | | | | |
| (parts by mass) | | | | | | | | | | |
| Chemipearl W700 | | | | | | 2.6 | | | | |
| (parts by mass) | | | | | | | | | | |
| Chemipearl WF640 | | | | | | | 2.6 | | | |
| (parts by mass) | | | | | | | | | | |
| Volume-average particle diameter of wax (μm) | 0.89 | 0.56 | 0.79 | 0.80 | 0.89 | 0.97 | 1.09 | — | — | 0.89 |
| Color development 1 | A | A | A | A | A | A | A | B | C | C |
| Color development 2 | A | —^{a} | —^{a} | —^{a} | —^{a} | —^{a} | —^{a} | B | C | C |
| Abrasion resistance 1 | A | B | B | B | A | A | A | C | B | A |
| Abrasion resistance 2 | A | A | A | A | A | A | A | C | A | A |
| Abrasion resistance 3 | A | —^{a} | —^{a} | —^{a} | —^{a} | —^{a} | —^{a} | C | B | A |

In the table, “—^{a}” represents that the aqueous ink could not be ejected by the thermal jet-system ink jet printer (Envy 450G, manufactured by Hewlett-Packard Company).

1. An ink comprising a wax, a pigment, a pigment dispersing resin, an aqueous medium, and if required, a binder resin, wherein the content of the wax is within a range of 0.5% by mass to 2% by mass relative to the total amount of the ink and the content of the binder resin is 0% by mass to 2% by mass relative to the total amount of the ink.

2. The ink according to claim 1, wherein the wax is polytetrafluoroethylene.

3. The ink according to claim 2, wherein the polytetrafluoroethylene has a volume-average particle diameter within a range of 0.5 μm to 1.5 μm.

4. The ink according to claim 1, wherein the binder resin is a polyurethane resin.

5. The ink according to claim 1, wherein the pigment dispersing resin is a resin having a structural unit derived from styrene and a structural unit derived from acrylic acid.

6. The ink according to claim 1, wherein the ink is used for printing in an ink jet printing system.

7. A printed matter comprising a recording medium printed with the ink according to claim 1.
